(19) United States
(12) Patent Application Publication
(10) Pub. No.: US 2020/0074293 A1
(43) Pub. Date: Mar. 5, 2020

(54) Computing Device for Multiple Activation Functions in Neural Networks

(71) Applicant: DINOPLUSAI HOLDINGS LIMITED, Fremont, CA (US)

(72) Inventors: Chung Kuang Chin, Saratoga, CA (US); Tong Wu, Fremont, CA (US); Ahmed Saber, Fremont, CA (US); Steven Sertillange, San Leandro, CA (US)

(73) Assignee: DINOPLUSAI HOLDINGS LIMITED

(21) Appl. No.: 16/116,029

(22) Filed: Aug. 29, 2018

(51) Int. Cl. G06N 3/08; G06F 7/575; G06N 3/04

(52) U.S. Cl. CPC G06N 3/08; G06N 3/04; G06F 7/575

(57) ABSTRACT

A scalar element computing device for computing a selected activation function selected from two or more different activation functions is disclosed. The scalar element computing device comprises N processing elements, N command memories and an operator pool. The N processing elements are arranged into a pipeline to cause the outputs of each non-last-stage processing element coupled to the inputs of one next-stage processing element. The N command memories are coupled to the N processing elements individually. The operator pool is coupled to the N processing elements, where the operator pool comprises a set of operators for implementing any activation function in an activation function group. The N processing elements are configured according to command information stored in the N command memories to calculate a target activation function selected from the activation function group by using one or more operators in the set of operations.

### FIELD OF THE INVENTION

The present invention relates to a computing device to support multiple activation functions as required in neural networks. In particular, the present invention relates to hardware architecture that achieves cost effectiveness as well as high processing throughputs over the conventional hardware structure.

### BACKGROUND

Today, artificial intelligence has been used in various applications such as perceptive recognition (visual or speech), expert systems, natural language processing, intelligent robots, digital assistants, etc. Artificial intelligence is expected to have various capabilities including creativity, problem solving, recognition, classification, learning, induction, deduction, language processing, planning, and knowledge. Neural network is a computational model that is inspired by the way biological neural networks in the human brain process information. Neural network has become a powerful tool for machine learning, in particular deep learning, in recent years. In light of power of neural networks, various dedicated hardware and software for implementing neural networks have been developed.

FIG. 1A illustrates an example of a simple neural network model with three layers, named as input layer 110, hidden layer 120 and output layer 130, of interconnected neurons. The output of each neuron is a function of the weighted sum of its inputs. A vector of values (X₁ . . . X_{MI}) is applied as input to each neuron in the input layer. Each input in the input layer may contribute a value to each of the neurons in the hidden layer with a weighting factor or weight (Wᵢⱼ). The resulting weighted values are summed together to form a weighted sum, which is used as an input to a transfer or activation function, ƒ(⋅) for a corresponding neuron in the hidden layer. Accordingly, the weighted sum, V, for each neuron in the hidden lay can be represented as:

Yⱼ=Σᵢ₌₁³WᵢⱼXᵢ, (1)

where Wᵢⱼ is the weight associated with Xᵢ and Yⱼ. In general, the total number of input signals may be M1, where M1 is an integer greater than 1. There may be N1 neurons in the hidden layer. The output, yᵢ at the hidden layer becomes:

yⱼ=f(Σᵢ₌₁³WᵢⱼXᵢ+b), (2)

where b is the bias.

The output values can be calculated similarly by using yⱼ as input. Again, there is a weight associated with each contribution from yⱼ. FIG. 1B illustrates an example of a simple neural network model with four layers, named as input layer 140, layer 1 (150), layer 2 (160) and output layer 170, of interconnected neurons. The weighted sums for layer 1, layer 2 and output layer can be computed similarly.

Accordingly, the function of each neuron can be modelled as weighted sum calculation 180 followed by an activation function 190 as shown in FIG. 1C. The output of each neuron may become multiple inputs for the next-stage neural network. Activation function of a node defines the output of that node given an input or set of inputs. The activation function decides whether a neuron should be activated or not. Various activation functions have been widely used in the field, which can be classified as a linear type and a nonlinear type. Nonlinear-type activation functions are widely used in the field and some examples of activation function are viewed as follows.

Sigmoid Function

The Sigmoid function curve 210 has an S-shape that looks like a form of the Greek letter Sigma as shown in FIG. 2A. The Sigmoid function is defined as:

$$f ( Y ) = \frac{1}{1 + {e}^{- Y}} . \qquad ( 3 )$$

Hyperbolic Tangent (Tan h) Function

The hyperbolic tangent function (tan h) has a shape 220 as shown in FIG. 2B. The hyperbolic tangent function is defined as:

$$f ( Y ) = \frac{{e}^{Y} - {e}^{- Y}}{{e}^{Y} + {e}^{- Y}} . \qquad ( 4 )$$

Rectified Linear Unit (ReLU) Function

The Rectified Linear Unit (ReLU) function is another popular non-linear activation function used in recent years. The Rectified Linear Unit function has a shape 230 as shown in FIG. 2C. The Rectified Linear Unit function corresponds to the maximum function with 0 as one parameter. The Rectified Linear Unit function is defined as:

f(Y)=max(0,Y). (5)

Leaky ReLU Function

For the ReLU function, all the negative values are mapped to 0, which decreases the ability of the model to fit or train from the data properly. In order to overcome this issue, a leaky ReLU function has been used. The leaky ReLU function has a shape 240 as shown in FIG. 2D. The leaky ReLU function is defined as:

$$f ( Y ) = \{ \begin{matrix}α Y & for Y < 0 \\ Y & for Y \geq 0\end{matrix} . \qquad ( 6 )$$

In the above equation, the value of a is often selected to be less than 1. For example, the value of a can be 0.01.

The activation functions mentioned above are intended for illustration instead of an exhaustive list of all activation functions. In practice, other activation functions, such as Softmax function, are also being used.

### SUMMARY OF INVENTION

A scalar element computing device for computing a selected activation function selected from two or more different activation functions is disclosed. The scalar element computing device comprises N processing elements, N command memories and an operator pool. Each processing element comprises one or more inputs and one or more outputs, and the N processing elements are arranged into a pipeline to cause said one or more outputs of each non-last-stage processing element coupled to said one or more inputs of one next-stage processing element, where N is an integer greater than 1. The N command memories are coupled to the N processing elements individually. The operator pool is coupled to the N processing elements, where the operator pool comprises a set of operators for implementing any activation function in an activation function group of two or more different activation functions. The N processing elements are configured according to command information stored in the N command memories to calculate a target activation function selected from said two or more different activation functions by using one or more operators in the set of operations.

In one embodiment, said two or more different activation functions comprise Sigmoid, Hyperbolic Tangent (tan h), Rectified Linear Unit (ReLU) and leaky ReLU activation functions. The set of operators may comprise addition, multiplication, division, maximum and exponential operator. In another embodiment, the set of operators comprises addition, multiplication, division, maximum, minimum, exponential operator, logarithmic operator, and square root operator. The set of operators may also comprise one or more pool operators, where each pool operator is applied to a sequence of values. For example, the pool operators correspond to ADD_POOL to add the sequence of values, MIN_POOL to select a minimum value of the sequence of values, MAX_POOL to select a maximum value of the sequence of values, or a combination thereof.

In one embodiment, the set of operators comprises a range operator to indicate range result of a first operand compared with ranges specified by one other second operand or two other operands. Furthermore, one processing element can be configured to use a target operator conditionally depending on the range result of the first operand in a previous-stage processing element.

In one embodiment, each of the N command memories is partitioned memory entries and each entry is divided into fields. For example, each entry comprises a command field to identify a selected command and related control information, one or more register fields to indicate values of one or more operands for a selected operator, and one or more constant fields to indicate values of one or more operands for the selected operator.

In one embodiment, the scalar element computing device may comprise a multiplexer to select one or more inputs of first-stage processing element from feeder interface corresponding to full sum data or one or more outputs of a last-stage processing element.

A method of using the above computing device is also disclosed. One or more operations required for a target activation function are determined. One or more target operators, corresponding to the operations, are selected from a set of operators supported by the operator pool. The target operators are mapped into the N processing elements arranged into the pipeline. The target activation function is calculated for an input data using the N processing elements by applying said one or more operations to the input data, where the N processing elements implement said one or more operations using said one or more target operators from the operator pools according to command information related to said one or more target operators stored in the N command memories respectively.

A scalar computing subsystem for computing a selected activation function selected from two or more different activation functions is also disclosed. The scalar computing subsystem comprises an interface module to receive input data for applying a selected activation function and M scalar elements coupled to the interface module to receive data to be processed. The scalar element is based on the scalar element computing device mentioned above. The scalar computing subsystem may further comprise a reduced operator pool coupled to all M scalar elements, where when a reduce operator is selected, each of the N processing elements in the M scalar elements provides a value for the reduced operator and uses a result of the reduced operator. The reduced operator pool may comprise an addition operator, a minimum operator and a maximum operator.

The scalar computing subsystem may further comprise an aligner coupled to all M scalar elements to align first data output from all M scalar elements. The scalar computing subsystem may further comprise a padder coupled to the aligner to pad second data output from the aligner. The input data corresponds to full sum data or memory data from a unified memory. The interface module comprises a multiplexer to select the input data from output data of a full sum calculation unit or looped-back outputs from last-stage processing elements in each scalar element.

### BRIEF DESCRIPTION OF THE DRAWINGS

FIG. 1A illustrates an example of neural network with an input layer, a hidden layer and an output layer.

FIG. 1B illustrates an example of neural network with an input layer, two internal layers and an output layer.

FIG. 1C illustrates exemplary functions of each neuron that can be modelled as weighted sum calculation followed by an activation function.

FIG. 2A illustrates the Sigmoid function curve having an S-shape that looks like a form of the Greek letter Sigma.

FIG. 2B illustrates the hyperbolic tangent activation function (tan h).

FIG. 2C illustrates the Rectified Linear Unit (ReLU) activation function.

FIG. 2D illustrates the leaky Rectified Linear Unit (ReLU) activation function.

FIG. 3 illustrates an example of a scalar element (SE) module according to an embodiment of the present invention, where the scalar element (SE) module can be used as a building block to form an apparatus for implementing various activation functions.

FIG. 4 illustrates an example of a scalar computing unit (SCU) subsystem according to an embodiment of the present invention based on the scalar element (SE) as shown in FIG. 3.

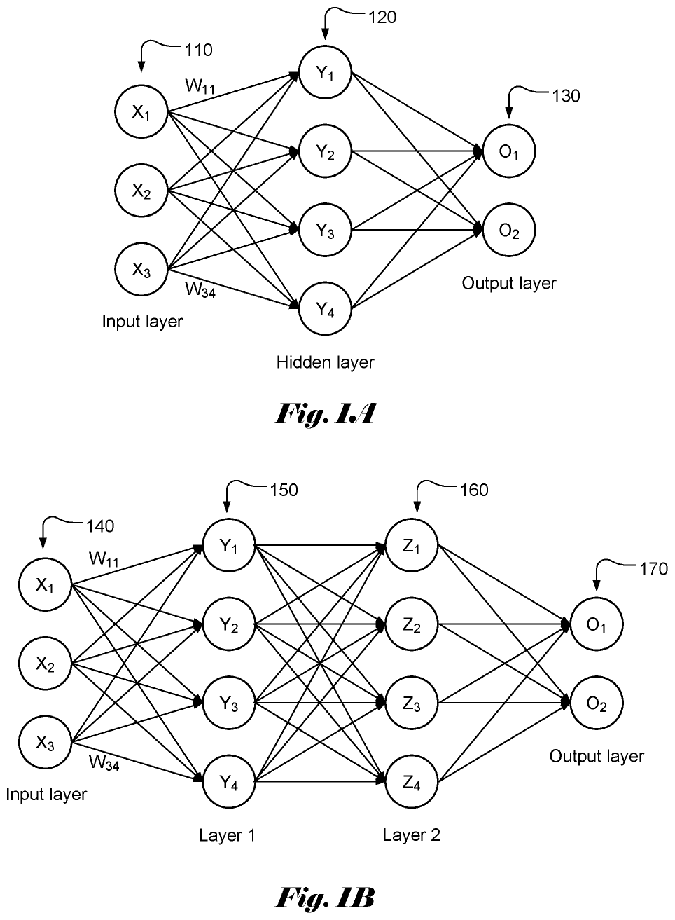

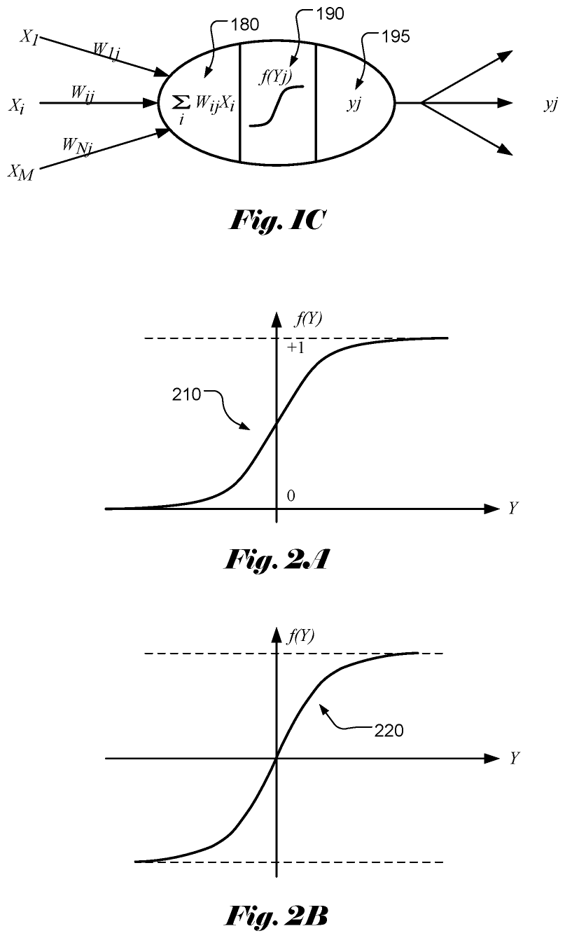

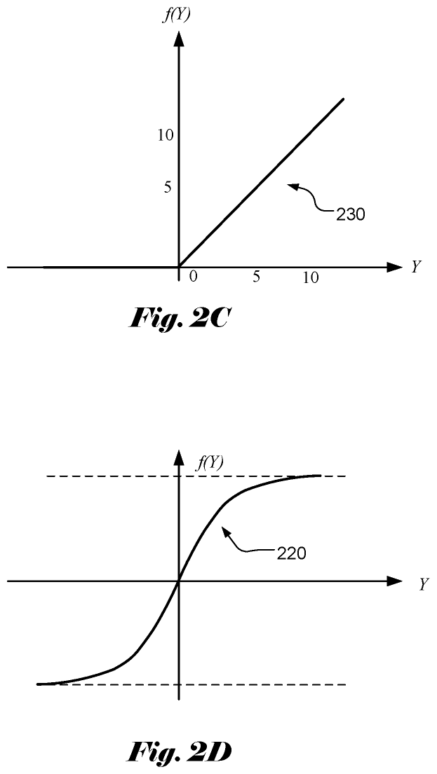

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

In the description like reference numbers appearing in the drawings and description designate corresponding or like elements among the different views.

As mentioned above, neural network implement may need to support various action functions. In theory, parallel sets of processors may be used in parallel to support the various action functions. For example, a system may have four sets of processors, where each set of the processors is dedicated for a particular activation function. In this case, four sets of processors will be needed to support the Sigmoid, tan h, ReLU and leaky ReLU activation functions. While such implementation is straightforward, the implementation may not be cost effective.

Scalar Element (Se) with Operator Pool

In this disclosure, an innovative architecture and related interfaces and operations are disclosed to support multiple activation functions. According to the present invention, the operations required to support the multiple activation functions are identified. The required operations are used as a common pool to support the implementation of various activation functions. Furthermore, in order to support high-speed operation, pipelined processing units are disclosed so that various operations can be performed concurrently in various pipeline stages.

As an example, the operations required to support the Sigmoid, tan h, ReLU and leaky ReLU activation functions will include addition (for Sigmoid and tan h), multiplication (for leaky ReLU), exponential function (for Sigmoid and tan h), maximum (for ReLU) and comparison (for leaky ReLU). In this example, it is assumed that negation of a value (e.g. “−Y” and “−e^{-Y}”) can be performed implicitly.

The set of operations to support a given set of activation functions may not be unique. For example, instead of implicitly implementing the negation of a value (e.g. “−Y” and “−e^{-Y}”), the negation of a value can be implemented by multiplying the value by a constant “−1”. Furthermore, some activation functions or some partial activation functions may be supported by a dedicated operation. For example, the ReLU activation function (Y)=max(0, Y) may be implemented by a special conditional operation corresponding to a ranging operation followed by a branching operation according to the ranging result of input signal. Such special conditional operation can efficiently implement any activation that uses different mapping functions depending on data range. The ReLU is an example of such activation function, where the output ƒ(Y) is equal to Y if Y is greater than 0. Otherwise, ƒ(Y) is equal to 0. The ranging operator may include two operands with the first operand as the input signal and the second operand as a threshold to be compared with the input signal. If the first operand is greater than (or smaller than) the second operand, the ranging result is equal to 0 (or 1). Otherwise, the ranging result is equal to 1 (or 0). In the next stage, different operations can be selected according to the ranging result. This special conditional operation can be used to implement ReLU by setting the second operand to 0. If the ranging result is equal to 0, the conditional operator can be set to result in Y. If the ranging result is equal to 1, the conditional operator can be set to result in 0. In another embodiment, the special conditional operation may have three operands, where the first operand is the input signal, and the second operand and the third operand are thresholds to be compared with the input signal. In this case, three different ranges can be determined to cause three ranging results (e.g. 0, 1 and 2).

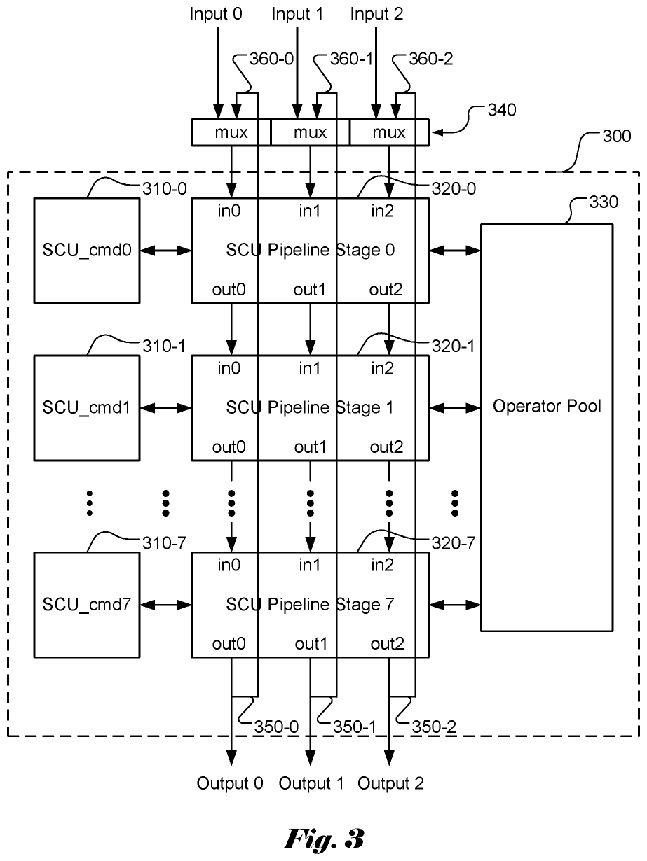

FIG. 3 illustrates an example of a scalar element (SE) module 300 according to an embodiment of the present invention. The disclosed scalar element (SE) module 300 can be used as a building block to form an apparatus for implementing various activation functions. The scalar element (SE) module 300 comprises multiple pipeline stages (e.g. N stages, N>1). In FIG. 3, the example corresponds to an SE module with 8 SCU (scalar computing unit) pipeline stages (i.e., N=8). Each SCU pipeline stage (i.e., SCU, 320-0, . . . , 320-7) is coupled to an individual SCU memory (i.e., 310-0, . . . , 310-7). The SCU pipeline stages (320-0 through 320-7) are coupled to a common operator pool 330 that is dedicated to the SE module. The common operator pool 330 comprises multiple operation resources to be used by the scalar computing units.

SCU Operator Pool

Each scalar computing unit comprises multiple pipeline inputs and multiple pipeline outputs. The example in FIG. 3 illustrates exemplary scalar computing units with 3 inputs (i.e., in0-in2) and 3 outputs (i.e., out0-out2) in each scalar computing unit pipeline stage. Nevertheless, the specific number of inputs and outputs is intended for illustrating an example of multiple inputs and outputs and, by no means, the specific number of inputs and outputs constitutes limitations of the present invention. Each SCU pipeline stage in an SE module is coupled to an operator pool (e.g. module 330 in FIG. 3) for the SE module. As mentioned before, the operator pool comprises circuitry or processors to support various operations required for implementing a selected activation function. In order to control the operations of each SCU pipeline stage, each SCU pipeline stage is coupled to a corresponding software-accessible SCU memory (e.g. SCU pipeline stage 0 coupled to SCU memory 0 (i.e., SCU_cmd0), SCU pipeline stage 1 coupled to SCU memory 1 (i.e., SCU_cmd1), etc.).

In order to support a set of activation functions consisting of sigmoid, tan h, ReLU and leaky ReLU, a set of operations comprising addition (ADD), multiplication (MULT), maximum (MAX), division (DIV) and exponential function (EXP) may be used as the operator pool to implement the set of activation functions. As mentioned before, the ReLU activation function may be implemented by a dedicated operator referred as condition branding (COND_BCH) in this disclosure, which determines the range of an input signal and selects an operator based on the ranging result. Similarly, the leaky ReLU activation function also involves comparison of an input with zero and then uses either “Y” or “aY” function depending on the comparison result as shown in equation (6). Therefore, an operator (e.g. pass through or no operation (NOP)) to cause ƒ(Y)=Y can be used when the input signal is greater than 0. For the input signal smaller than 0, the multiplication (MULT) operator can be used to cause ƒ(Y)=aY. The comparison operation may also be implemented using the MIN or MAX operator with 0 as one operand. The actual operator is selected according to the comparison result. Accordingly, in another embodiment, the set of operations comprising addition (ADD), multiplication (MULT), maximum (MAX), COND_BCH division (DIV) and exponential function (EXP) may be used as the operator pool for implementing the set of activation functions. The set of operations may include both maximum (MAX) and minimum (MIN).

In some applications, an operation may be applied to a sequence of data. For example, it may be needed to add up a sequence of input values. In order to implement such operation efficiently, a new operator (ADD_POOL) that can add up a sequence of values is disclose. For example, ADD_POOL may accumulate operand 0, where the accumulator is cleared when first of pool signal is active. The accumulation result will be outputted when the last pool signal is active. When both first pool and last pool signals are active, ADD_POOL will function as ADD. ADD_POOL will also output pool size. The ADD_POOL operator provides the accumulated value and the pool size for a sequence of values. The results of ADD_POOL can be used to calculate the average of a sequence of values by dividing the accumulated value by the pool size. Accordingly, a special division operator is disclosed to perform the division of an accumulated value by the pool size. Similarly, the operation on a sequence of data may also be applicable to MIN and MAX. For example, MAX_POOL can be used for the MAX operation on a sequence of data, which outputs the maximum value of a sequence of operand 0 when the last pool signal is active. The start of a pool is indicated by the first pool signal. When both first of pool and last of pool are active, MAX_POOL will function as MAX. In another example, MIN_POOL can be used for the MIN operation on a sequence of data, which outputs the minimum value of a sequence of operand 0 when the last pool signal is active. The start of a pool is indicated by the first pool signal. When both first of pool and last of pool are active, MIN_POOL will function as MIN.

The operator pool may comprise multiple copies of one operator. For example, the operator pool may comprise two copies of ADD (e. g. ADDa and ADDb) so that the addition operation can be used by two pipeline stages at the same time. If only one copy of ADD is available in the operator pool, two different pipeline stages would have to take turns to share the same ADD operator.

While the exemplary sets of operators are adequate to support major existing activation functions, there may be other activation functions that may be used. In yet another embodiment of the present invention, an extended set of operators may be used to support a variety of activation functions. For example, the set of operators may further comprise a logarithmic operator (LN) and a square-root operator (SQRT) to support other activation functions.

Individual SCU Operator Pool and Global Operator Pool

In FIG. 3, the SCU pipeline stages are coupled to an operator pool. A dedicated operator pool can be used for each SCU pipeline stage so that the multiple SE modules can perform desired operations concurrently. Nevertheless, in some circumstances, it may be desired that multiple SEs are used and all SE modules perform a same operation. In this case, all SEs will send one value to the operator selected from a global operator pool. The operation result will be saved in the global operator itself and can be selected to be used by all pipeline stages of all SEs. The global operator is also referred as a “reduced” operator in this disclosure since values from all SEs are “reduced” (or summed) to one value. When a global operator pool (i.e., reduced operator pool) is used, the global operator pool is used as an additional operator pool connected to all pipeline stages of all SEs.

The reduced operator is useful for some operators that are applied to all SEs. For example, values of pipeline stages from all SEs may be summed using a reduced ADD operator (e.g. REDUCE_OP_ADD). In another example, it may be needed to find a minimum among values of pipeline stages from all SEs. In this case, a reduced minimum operator (e.g. REDUCE_OP_MIN) may be used. Similarly, it may be needed to find a maximum among values of pipeline stages from all SEs. In this case, a reduced maximum operator (e.g. REDUCE_OP_MAX) may be used.

SCU Pipeline Stages with Loop Back

In another embodiment, the output from the last SCU pipeline stage can be looped back to the input of the first SCU pipeline stage so as to increase length of the pipeline stages. For example, the outputs (i.e., 350-0, 350-1 and 350-2) from the SCU pipeline stage 7 can be looped back to the inputs (i.e., 360-0, 360-1 and 360-2) through multiplexers 340. The multiplexers 340 can be configured to select the looped back inputs (i.e., 360-0, 360-1 and 360-2) or inputs (input 0, input 1 and input 2) from the full sum feeder.

SCU Memory Data Structure

The SCU memory includes the needed information to control the operation of the corresponding SCU pipeline stage. For example, each SCU memory may include multiple entries (e.g. Si entries and Si being a positive integer greater than 1) and each entry may consist of multiple bits (e.g. S2 bits and S2 being a positive integer greater than 1) partitioned into various fields. For example, the SCU memory may include 128 entries (i.e., S1=128). The 128 entries are organized as 32 sets of loop of 4 commands. Each SCU Pipeline Stage will receive 5-bit command address (cmd_addr) to indicate the set of commands to use. Each entry consists of 192 bits i.e., S2=192), which may be divided into 6 fields with 32 bits for each field. In the following, an example of data structure for the SCU memory is illustrated:
1. Fields 0 to 2: scu_registers for each SCU pipeline stage; scu_registers correspond to values that can be used as operands for a selected operator from the operator pool.
2. Fields 3 to 4: scu_constants for each SCU pipeline stage; scu_constants are also values that can be used as operands for selected operator from the operator pool
3. Field 5: scu_command specifies scu_command to be performed and information related to the operation. When reduced operators are used, the operator selected may correspond to a reduced operator.

Operator Selection

The scu_command includes a field consisting of multiple bits for selecting an operator. The number of bits for indicating a selected operator depends on the number of operators available for selection. For example, a 5-bit field will be able to identify up to 32 different operators to select from.

As mentioned earlier, an extended set of operators may be used to support a large variety of activation functions. In this case, scu_command is designed to accommodate the inclusion of the set of extended operators.

When the reduced operators are used, selection of a reduced operator should be indicated. Accordingly, scu_command is designed to accommodate the inclusion of reduced operators in this case.

Pipeline Output Selection

In order to provide flexibility, the SCU pipeline stage may be configured to allow selectable output. For example, out1 and out2 may be set to select pipeline input 1 and pipeline input 2 respectively; or out1 and out2 may be set to select respective operator outputs. In this case, the information related to the operation may include one or more bits to indicate the pipeline output selection.

Operand Selection

In order to provide flexibility, the SCU pipeline stage may be configured to allow operand selection. For example, the operand 0 may be selected from a group comprising one of the three inputs (i.e., in0, in1 and in2) of the SCU pipeline stage, from a register, or from the result of a reduced operation. The operand 1 may be selected from a group comprising one of the three inputs (i.e., in0, in1 and in2) of the SCU pipeline stage, a register, a constant, or the result of a reduced operation.

COND_BCH Operator

In order to the special conditional operation, an entry for such operation may use the input signal and two scu_registers as three operands, where the first operand corresponds to the input signal to be processed and the second and third operands are used for values of thresholds to be compared with. For example, the operation outputs cmp_result=0 if operand 0>operand 1; the operation outputs cmp_result=1 if operand 0<=operand 1 and operand 0>=operand 2; and the operation outputs cmp_result=2 if operand 0<operand 2.

In order to support conditional operation, the scu_command may include one or more bits to indicate whether to use different operations depending on the ranging result. For example, one “use compare result” bit can be set or unset to indicate whether to use the ranging result. When “use compare result” bit of the scu_command is set, the cmp_result of the last pipeline stage will be used to determine the actual command to be used. Accordingly, when the “use compare result” bit is set, scu_constants can be further used to indicate a corresponding operator selected for a ranging result. For example, when cmp_result=1, scu_constant[0] will be used to replace scu_command. The “use compare result” and “operator select” bits of scu_constant[0] will be ignored. When cmp_result=2, scu_constant [1] will be used to replace scu_command. The “use compare result” and “operator select” bits of scu_constant[1] will be ignored.

Cmp_result can be propagated through the SCU pipeline stages including loopback until the cmp_result is replaced by a new cmp_result from the MIN, MAX, or COND_BCH operator.

Loop Count

As mentioned before, the output from the last pipeline stage can be looped back to the input of the first stage. According to one embodiment of the present invention, the system can be configured to allow multiple loops of operation. For example, one or more bits in the scu_cmd can be used to indicate or control the number of loops of operations. For example, the 2 LSBs of the memory address can be used for the loop count, which indicates one of the 4 passes through the 8 pipeline stages. In order to increase the efficiency, the last SCU pipeline stage may use a separate memory.

Table 1 illustrates an exemplary data structure for scu_cmd.

| Bit Index | Default | Access Type | Description |
|---|---|---|---|
| 0 | ′0 | RW | Pipeline output 2 mux select |
| | | | 0: select pipeline input 2 |
| | | | 1: select operator output |
| 1 | ′0 | RW | Pipeline output 1 mux select |
| | | | 0: select pipeline input 1 |
| | | | 1: select operator output |
| 3:2 | ′0 | RW | Reserved |
| 8:4 | ′0 | RW | Operator select |
| | | | #define REDUCE_OP_ADD 16 |
| | | | #define REDUCE_OP_MAX 17 |
| | | | #define REDUCE_OP_MIN 18 |
| | | | #define ADD 0 |
| | | | #define ADD_POOL 1 |
| | | | #define MULT0 2 |
| | | | #define MULT1 3 |
| | | | #define MAX 4 |
| | | | #define MAX_POOL 5 |
| | | | #define MIN 6 |
| | | | #define MIN_POOL 7 |
| | | | #define EXP 8 |
| | | | #define LN 9 |
| | | | #define RELU 10 |
| | | | #define DIV0 11 |
| | | | #define DIV1 12 |
| | | | #define SQRT 13 |
| | | | #define DIV2 27 |
| | | | #define DIV3 28 |
| | | | 14~15, and 19~26, 29~31: NOP |
| | | | DIV2 and DIV3 are using the same hardware as |
| | | | DIV0 and DIV1 except that operand 1 will be from |
| | | | ADD_POOL pool size result. |
| 11:9 | ′0 | RW | Operand 1 select |
| | | | #define OP1_RG1 0 // select one register |
| | | | #define OP1_CONST 1 // select one constant |
| | | | #define OP1_IN1 2 // select input 1 |
| | | | #define OP1_IN2 3 // select input 2 |
| | | | #define OP1_AB 4 // select AB |
| | | | #define OP1_IN 5 // select input 0 |
| | | | #define OP1_ROP 6 // select reduced op results |
| 14:12 | ′0 | RW | Operand 0 select |
| | | | #define OP0_IN 0 |
| | | | #define OP0_IN1 1 |
| | | | #define OP0_XIN 2 // select cross channel in |
| | | | #define OP0_RG0 3 // select one register |
| | | | #define OP0_IN 4 // select input 0 |
| | | | #define OP0_IN2 5 |
| | | | #define OP0_ROP 6 |
| 15 | ′0 | RW | Pipeline output enable; set to 0 for pooling |
| 16 | ′0 | RW | Use compare result; set to 1 to use compare result of |
| | | | the previous stage for replacing scu_command with |
| | | | scu_constants |
| 17:17 | ′0 | RW | Constant select |
| 19:18 | ′0 | RW | Register 1 select |
| 21:20 | ′0 | RW | Register 0 select |
| 30:22 | ′0 | RW | Unused |
| 31 | ′0 | RW | Last stage: to instruct the following stages not to |
| | | | fetch command; note that scu_pipe_stages only |
| | | | fetch scu_commands when first_full_sum is set |

Scalar Computing Unit (SCU) Subsystem

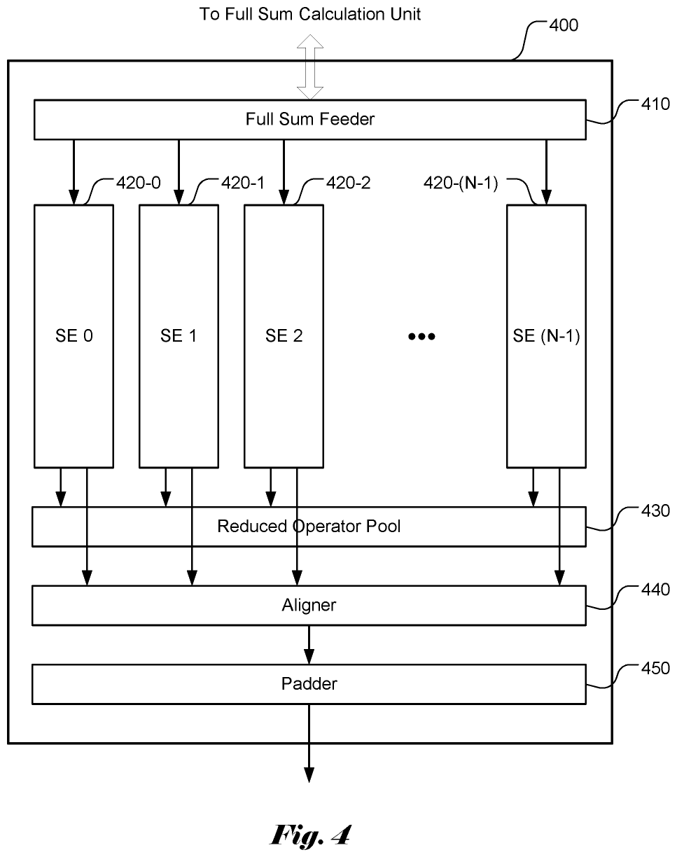

The scalar element (SE) as shown in FIG. 3 can be used as a building block to form an SCU subsystem to perform multi-channel activation function computation concurrently. FIG. 4 illustrates an example of a SCU subsystem 400 that comprises N scalar elements. As shown in FIG. 4, the subsystem comprises M scalar elements (420-0, 420-1, . . . , 420-(M−1)), where M is a positive integer greater than 1. For example, M can be set to 256. The SCU subsystem also includes an input interface (referred as Full Sum Feeder 410) to interface with a full sum computing unit, which computes full sums based on input signals. As shown in FIG. 3, each SE has its own operator pool within the SE module. The SEs are also coupled to a global operator pool 430 (also referred as a reduced operator pool). When a reduced operator is selected, all SCU pipeline stages of all SEs will use the same reduce operator. The result of the reduced operator can be used by all SCU pipeline stages of all SEs. FIG. 4 also shows optional components (i.e., Aligner 440 and Padder 450) of the SCU subsystem. The system is intended to support data in various bit depths, such as 8-bit integer (INT8 or UNITE), 16-bit floating-point data (FP16) or 32-bit floating-point data (FP32). Data in different bit-depths should be aligned and padded properly before they are written to memory.

The Mux 340 as shown in FIG. 3 can be regarded as part of the Full Sum Feeder 410 in FIG. 4. The SCU subsystem work with a full sum computing unit by applying the activation functions to the full sums computed by the full sum computing unit. The innovative structure of the SEs can implement various activation functions cost effectively and in high speed.

The above description is presented to enable a person of ordinary skill in the art to practice the present invention as provided in the context of a particular application and its requirement. The invention may be embodied in other specific forms without departing from its spirit or essential characteristics. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Various implementations of the systems and techniques described here can be realized in digital electronic circuitry, integrated circuitry, specially designed ASICs (application specific integrated circuits), field programmable gate array (FPGA), and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor. The software code or firmware codes may be developed in different programming languages and different format or style. The software code may also be compiled for different target platform. However, different code formats, styles and languages of software codes and other means of configuring code to perform the tasks in accordance with the invention will not depart from the spirit and scope of the invention.

1. A scalar element computing device for computing a selected activation function selected from two or more different activation functions, the scalar element computing device comprising:
N processing elements, wherein each processing element comprises one or more inputs and one or more outputs, and the N processing elements are arranged into a pipeline to cause said one or more outputs of each non-last-stage processing element coupled to said one or more inputs of one next-stage processing element, wherein N is an integer greater than 1;
N command memories, wherein the N command memories are coupled to the N processing elements individually; and
an operator pool coupled to the N processing elements, wherein the operator pool comprises a set of operators for implementing any activation function of two or more different activation functions; and
wherein the N processing elements are configured according to command information stored in the N command memories to calculate a target activation function selected from said two or more different activation functions by using one or more operators in the set of operations.

2. The scalar element computing device of claim 1, wherein said two or more different activation functions comprise Sigmoid, Hyperbolic Tangent (Tan h), Rectified Linear Unit (ReLU) and leaky ReLU activation functions.

3. The scalar element computing device of claim 1, wherein the set of operators comprises addition, multiplication, division, maximum and exponential operator.

4. The scalar element computing device of claim 1, wherein the set of operators comprises addition, multiplication, division, maximum, minimum, exponential operator, logarithmic operator, and square root operator.

5. The scalar element computing device of claim 1, wherein the set of operators comprises one or more pool operators, wherein each pool operator is applied to a sequence of values.

6. The scalar element computing device of claim 5, wherein said one or more pool operators correspond to ADD_POOL to add the sequence of values, MIN_POOL to select a minimum value of the sequence of values, MAX_POOL to select a maximum value of the sequence of values, or a combination thereof.

7. The scalar element computing device of claim 1, wherein the pipeline is configured to cause said one or more outputs from a last-stage processing element looped back to said one or more inputs of a first-stage processing element.

8. The scalar element computing device of claim 1, wherein the set of operators comprises a range operator to indicate range result of a first operand compared with ranges specified by one other second operand or two other operands.

9. The scalar element computing device of claim 8, wherein one processing element is configured to use a target operator conditionally depending on the range result of the first operand in a previous-stage processing element.

10. The scalar element computing device of claim 1, wherein each of the N command memories is partitioned memory entries and each entry is divided into fields.

11. The scalar element computing device of claim 10, wherein each entry comprises a command field to identify a selected command and related control information, one or more register fields to indicate values of one or more operands for a selected operator, and one or more constant fields to indicate values of one or more operands for the selected operator.

12. The scalar element computing device of claim 1, wherein an indication in command field of each of the N command memories is used to instruct whether following stages of one processing element fetch command or not; and wherein one processing element only fetches one or more commands only when a first full sum is set.

13. The scalar element computing device of claim 1, further comprising a multiplexer to select one or more inputs of first-stage processing element from feeder interface corresponding to full sum data or one or more outputs of a last-stage processing element.

14. A method for computing a selected activation function belonging to two or more different activation functions using an operator pool and N processing elements arranged into a pipeline and coupled to N command memories individually, wherein N is an integer greater than 1, the method comprising:
determining one or more operations required for a target activation function;
selecting one or more target operators, corresponding to said one or more operations, from a set of operators supported by the operator pool;
mapping said one or more target operators into the N processing elements arranged into the pipeline; and
calculating the target activation function for input data using the N processing elements by applying said one or more operations to the input data, wherein the N processing elements implement said one or more operations using said one or more target operators from the operator pools according to command information related to said one or more target operators stored in the N command memories respectively.

15. A scalar computing subsystem for computing a selected activation function selected from two or more different activation functions, the scalar computing subsystem comprising:
an interface module to receive input data for applying a selected activation function; and
M scalar elements coupled to the interface module to receive data to be processed, wherein M is an integer equal to or greater than 1; and
wherein each scalar element comprises:
N processing elements, wherein each processing element comprises one or more local inputs and one or more local outputs, and the N processing elements are arranged into a pipeline to cause one or more local outputs of each non-last-stage processing element coupled to one or more local inputs of one next-stage processing element, wherein N is an integer greater than 1;
N command memories, wherein the N command memories are coupled to the N processing elements individually; and
an operator pool couples to the N processing elements, wherein the operator pool comprises a set of operators for implementing any activation function of two or more different activation functions; and
wherein the N processing elements are configured according to command information stored in the N command memories to calculate a target activation function selected from said two or more different activation functions by using one or more operators in the set of operations.

16. The scalar computing subsystem of claim 15, further comprising a reduced operator pool coupled to all M scalar elements, wherein when a reduce operator is selected, each of the N processing elements in the M scalar elements provides a value for the reduced operator and uses a result of the reduced operator.

17. The scalar computing subsystem of claim 16, the reduced operator pool comprises an addition operator, a minimum operator and a maximum operator.

18. The scalar computing subsystem of claim 15, further comprising an aligner coupled to all M scalar elements to align first data output from all M scalar elements.

19. The scalar computing subsystem of claim 18, further comprising a padder coupled to the aligner to pad second data output from the aligner.

20. The scalar computing subsystem of claim 15, wherein the input data corresponds to full sum data or memory data from a unified memory.

21. The scalar computing subsystem of claim 15, wherein the interface module comprises a multiplexer to select the input data from output data of a full sum calculation unit or looped-back outputs from last-stage processing elements in each scalar element.
